(19) United States
(12) Patent Application Publication
(10) Pub. No.: US 2011/0034367 A1
(43) Pub. Date: Feb. 10, 2011

(54) Liquid Enzyme Composition

(75) Inventors: Ole Simonsen, Soeborg (DK); Juergen Carsten Franz Knoetzel, Copenhagen Oe (DK); Lone Kierstein Nielsen, Kongens Lyngby (DK)

Correspondence Address: NOVOZYMES NORTH AMERICA, INC., 500 FIFTH AVENUE, SUITE 1600, NEW YORK, NY, 10110, US

(73) Assignee: Novozymes A/S

(21) Appl. No.: 12/864,472

(22) PCT Filed: Jan. 29, 2009
(86) PCT No.: PCT/EP09/50977

§ 371 Date: Sep. 14, 2010

Related U.S. Application Data
(60) Provisional application No. 61/025,884, filed on Feb. 4, 2008.

(30) Foreign Application Priority Data
Feb. 1, 2008 (EP) 08150977.0

(51) Int. Cl. C11D 3/386

(52) U.S. Cl. 510/393

(57) ABSTRACT

Incorporation of a serine protease inhibitor such as RASI, BASI, WASI (bifunctional alpha-amylase/subtilisin inhibitors of rice, barley and wheat) into a liquid detergent which contains a serine proteasecan stabilize the serine protease and/or a second enzyme and can release the enzyme when the detergent composition is diluted.

### REFERENCE TO A SEQUENCE LISTING

This application contains a Sequence Listing in computer readable form. The computer readable form is incorporated herein by reference.

### FIELD OF THE INVENTION

The present invention relates to a liquid detergent composition comprising a surfactant, a serine protease and a protease inhibitor.

### BACKGROUND OF THE INVENTION

Proteases, especially serine proteases such as subtilisins, are widely used as ingredients in commercial detergents. A major problem in formulating protease-containing detergents, especially liquid detergents, is that of ensuring enzyme stability during storage.

WO 1992/003529 (Novo Nordisk) discloses a detergent composition comprising a protease and one or more other enzymes, as well as comprising a reversible protease inhibitor of the peptide or protein type, particularly an inhibitor of family VI.

WO 1992/005239 (Novo Nordisk) discloses a detergent composition and additive comprising a protease and a reversible protease inhibitor of the peptide or protein type, wherein the ratio of dissociation constant to the protease concentration in the range from 0.006 to 6. When the protease is subtilisin, the protease inhibitor is preferably a modified subtilisin inhibitor of Family VI.

BASI, RASI and WASI (barley, rice and wheat alpha-amylase/subtilisin inhibitor) are described by B. C. Bønsager et al., The Journal of Biological Chemistry, vol. 280, pp. 14855-14864 (2005); and T. Yamasaki et al., Biosci. Biotechnol. Biochem., 70 (5), 1200-1209 (2006).

### SUMMARY OF THE INVENTION

The inventors have found that incorporation of a serine protease inhibitor such as RASI, BASI, WASI (bifunctional alpha-amylase/subtilisin inhibitors of rice, barley and wheat) into a liquid detergent which contains a serine protease can stabilize the serine protease and/or a second enzyme and can release the enzyme when the detergent composition is diluted.

Accordingly, the invention provides a liquid detergent composition comprising a surfactant, a serine protease and a serine protease inhibitor wherein the inhibitor has an amino acid sequence such as RASI, BASI, or WASI or a homologue with at least 50% identity.

### DETAILED DESCRIPTION OF THE INVENTION

### Serine Protease Inhibitor

The serine protease inhibitor is a polypeptide which may have the amino acid sequence of RASI, BASI or WASI (SEQ ID NO: 1, 2 or 3), or it may be a close homologue of any of these. Thus, the inhibitor may have at least 50% identity to the mature peptide or it may comprise a sequence having at least 50% identity to residues 68-97 of SEQ ID NO: 1 (RASI), 67-96 of SEQ ID NO: 2 (BASI) or 67-96 of SEQ ID NO: 3. The identity may particularly be at least 60%, at least 70%, at least 80%, at least 85%, at least 90%, at least 95% or at least 98%.

### Sequence Identity

The degree of identity between two amino acid sequences is calculated as the number of exact matches in an alignment of the two sequences, divided by the length of the shorter of the two sequences. The result is expressed in percent identity. An exact match occurs when the two sequences have identical amino acid residues in the same positions of the overlap. The length of a sequence is the number of amino acid residues in the sequence.

The alignment of the two amino acid sequences may be determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

Alternatively, the alignment may be done by using the MegAlign program (version 7) developed by DNASTAR Inc., part of the Lasergene suite, based on Hein, J. J. (1990). “Unified approach to alignment and phylogenies.” In Methods in Enzymology, Vol. 183: pp. 626-645. Using the Jotun Hein Method and the settings GAP PENALTY=11, GAP LENGTH PENALTY=3 for multiple alignments and KTUPLE=2 for pairwise alignments a series of percentage identity values can be calculated.

### Serine Protease

The serine protease may be of animal, vegetable or microbial origin. It may be a serine protease, preferably an alkaline microbial protease or a trypsin-like protease. Examples of serine proteases are subtilisins, especially those derived from Bacillus, e.g., subtilisin Novo, subtilisin Carlsberg, subtilisin BPN′, subtilisin 309, subtilisin 147 and subtilisin 168 (described in WO 89/06279). Examples of trypsin-like proteases are trypsin (e.g. of porcine or bovine origin) and the Fusarium protease described in WO 89/06270.

Examples of commercially available serine proteases (peptidases) include Kannase™, Everlase™, Esperase™, Alcalase™, Neutrase™, Durazym™, Savinase™, Ovozyme™, Liquanase™, Polarzyme™, Pyrase™, Pancreatic Trypsin NOVO (PTN), Bio-Feed™ Pro and Clear-Lens™ Pro (all available from Novozymes A/S, Bagsvaerd, Denmark). Preferred serine proteases include those described in WO 1998/020115, WO 01/44452, WO 01/58275, WO 01/58276, WO 2003/006602, and WO 2004/099401.

Other commercially available serine proteases include Ronozyme™ Pro, Maxatase™, Maxacal™, Maxapem™, Opticlean™, Properase™, Purafect™, Purafect Ox™ and Purafact Prime™ (available from Genencor International Inc., Gist-Brocades, BASF, or DSM Nutritional Products).

### Optional Second Enzyme

In addition to the serine protease, the liquid composition may optionally comprise one or more other enzymes, e.g. selected among amylases, lipolytic enzymes (particularly lipases), cellulases, mannanases and oxidoreductases.

The amylase may be an alpha-amylase of bacterial or fungal origin, e.g. an alpha-amylase from B. licheniformis, described in GB 1,296,839. Commercially available amylases are Duramyl™, Termamyl™, Stainzyme™, Stainzyme Plus™, Termamyl Ultra™, Fungamyl™ and BAN™ (available from Novozymes NS) and Rapidase™, Maxamyl P™, Purastar and Purastar OxAm (available from Gist-Brocades and Genencor Inc.).The cellulase may be of bacterial or fungal origin. It may be a fungal cellulase from Humicola insolens (U.S. Pat. No. 4,435,307) or from Trichoderma, e.g. T. reesei or T. viride. Examples of cellulases are described in EP 0 495 257. Commercially available cellulases include Carezyme™, Celluzyme™, Endolase™ (available from Novozymes), Puradax, Puradax HA, and Puradax EG (available from Genencor).

The oxidoreductase may be a peroxidase or an oxidase such as a laccase. The peroxidase may be of plant, bacterial or fungal origin. Examples are peroxidases derived from a strain of Coprinus, e.g., C. cinerius or C. macrorhizus, or from a strain of Bacillus, e.g., B. pumilus, particularly peroxidase according to WO 91/05858. Suitable laccases herein include those of bacterial or fungal origin. Examples are laccases from Trametes, e.g., T. villosa or T. versicolor, or from a strain of Coprinus, e.g., C. cinereus, or from a strain of Myceliophthora, e.g., M. thermophila.

The lipolytic enzyme may be a lipase or cutinase of bacterial or fungal origin. Examples include a lipase from Thermomyces lanuginosus (Humicola lanuginosa) described in EP 258 068 and EP 305 216, a Rhizomucor miehei lipase, e.g., as described in EP 238 023, a Candida lipase, such as a C. antarctica lipase, e.g., the C. antarctica lipase A or B described in EP 214 761, a Fusarium oxysporum lipase (WO 98/26057), a Pseudomonas lipase such as a P. pseudoalcaligenes and P. alcaligenes lipase, e.g., as described in EP 218 272, a P. cepacia lipase, e.g., as described in EP 331 376, a P. stutzeri lipase, e.g., as disclosed in BP 1,372,034, a P. fluorescens lipase, a Bacillus lipase, e.g., a B. subtilis lipase (Dartois et al., (1993), Biochemica et Biophysica acta 1131, 253-260), a B. stearothermophilus lipase (JP 64/744992), B. pumilus lipase (WO 91/16422), Penicillium camenbertii lipase (Yamaguchi et al., (1991), Gene 103, 61-67), the Geotrichum candidum lipase (Shimada, Y. et al., (1989), J. Biochem. 106, 383-388), and various Rhizopus lipases such as a R. delemar lipase (Hass,

M. J et al., (1991), Gene 109, 117-113), a R. niveus lipase (Kugimiya et al., (1992), Biosci. Biotech. Bio-chem. 56, 716-719) and a R. oryzae lipase. Additional examples are cutinase from Pseudomonas mendocina (WO 88/09367), cutinase from Fusarium solani pisi (WO 90/09446) and cutinase from Humicola insolens (WO 2001/092502). The lipolytic enzyme may be a lipase variant, e.g. described in WO 2000/060063.

Examples of commercially available lipases include Lipex™, Lipoprime™, Lipopan™, Lipopan F™, Lipopan Xtra™, Lipolase™, Lipolase™ Ultra, Lipozyme™, Palatase™, Resinase™, Novozym™ 435 and Lecitase™ (all available from Novozymes A/S). Other commercially available lipases include Lumafast™ (Pseudomonas mendocina lipase from Genencor International Inc.); Lipomax™ (Ps. pseudoalcaligenes lipase from Gist- Brocades/Genencor Int. Inc.; and Bacillus sp. lipase from Solvay enzymes. Further lipases are available from other suppliers such as Lipase P “Amano” (Amano Pharmaceutical Co. Ltd.).

Examples of mannanases include MannawayTM (product of Novozymes) and MannaStar (product of Genencor).

### Liquid Detergent Composition

The invention is particularly applicable to the formulation of liquid detergents where enzyme stability problems are pronounced. The liquid detergent may be aqueous, typically containing 20-70% water and 0-20% organic solvent (hereinafter, percentages by weight).

The detergent comprises a surfactant which may be anionic, non-ionic, cationic, amphoteric or a mixture of these types. The detergent will usually contain 5-30% anionic surfactant such as linear alkyl benzene sulphonate (LAS), alpha-olefin sulphonate (AOS), alcohol ethoxy sulphate (AES) or soap. It may also contain 3-20% anionic surfactant such as nonyl phenol ethoxylate or alcohol ethoxylate.

The pH (measured in aqueous detergent solution) will usually be neutral or alkaline, e.g. 7-10. The detergent may contain 1-40% of a detergent builder such as zeolite, phosphate, phosphonate, citrate, NTA, EDTA or DTPA, or it may be unbuilt (i.e. essentially free of a detergent builder). It may also contain other conventional detergent ingredients, e.g. fabric conditioners, foam boosters, bactericides, optical brighteners and perfumes.

The detergent composition may be a fabric cleaning compositions, hard surface cleansing compositions, light duty cleaning compositions including dish cleansing compositions and automatic dishwasher detergent compositions.

The liquid composition may comprise from about 0.0001% to about 10%, more particularly from about 0.001% to about 1%, and most particularly from about 0.01% to about 0.1% of the inhibitor.

The molar ratio of the inhibitor to the serine protease may be from about 100:1 to about 1:1, more particularly from about 10:1 to about 1.5:1, and most particularly about 3:1.

Thus, a stabilized liquid enzyme formulation typically contains 1-10% by weight of enzyme protein (total of serine protease and optional second enzyme) and 2-25% by weight of the inhibitor

A liquid detergent formulation will typically contain 0.04-40 micromolar enzyme or 1-1000 mg/l of pure enzyme protein and about 3 times more of the inhibitor, i.e. 0.12-120 micromolar of inhibitor.

The liquid detergent composition may contain water and other solvents as carriers. Low molecular weight primary or secondary alcohols exemplified by methanol, ethanol, propanol, and iso-propanol are suitable. Monohydric alcohols are preferred for solubilizing surfactants, but polyols such as those containing from about 2 to about 6 carbon atoms and from about 2 to about 6 hydroxy groups (e.g., 1,3-propanediol, ethylene glycol, glycerine, and 1,2-propanediol) can also be used. The compositions may contain from about 5% to about 90%, typically from about 10% to about 50% of such carriers.

The detergent compositions herein will preferably be formulated such that during use in aqueous cleaning operations, the wash water will have a pH between about 6.8 and about 11. Finished products are typically formulated at this range. Techniques for controlling pH at recommended usage levels include the use of, for example, buffers, alkalis, and acids. Such techniques are well known to those skilled in the art.

When formulating the hard surface cleaning compositions and fabric cleaning compositions of the present invention, the formulator may wish to employ various builders at levels from about 5% to about 50% by weight. Typical builders include the 1-10 micron zeolites, polycarboxylates such as citrate and oxydisuccinates, layered silicates, phosphates, and the like. Other conventional builders are listed in standard formularies.

### EXAMPLES

### Example 1: Stabilization of Savinase by BASI in 4 different detergents

Four liquid detergents were prepared with the compositions shown below:

Detergent 1 (American liquid-type detergent without LAS) Dosage in Assay:1.5g/L.

Detergent 2 (American liquid-type detergent with LAS) Dosage in Assay:1.5g/L.

Detergent 3 (European liquid-type detergent without LAS) Dosage in Assay: 6g/L.

Detergent 4 (European liquid-type detergent with LAS) Dosage in Assay: 6g/L.

| Component, % w/w | Det 1 | Det 2 | Det 3 | Det 4 |
|---|---|---|---|---|
| Sodium alkylethoxy sulphate (C9-15, 2EO) | 14.0 | 7.4 | | |
| Sodium dodecyl benzene sulphonate (LAS) | | 5.5 | | 10.0 |
| Sodium lauryl sulphate | | | 17.0 | |
| Sodium toluene sulphonate | 3.0 | 1.0 | 3.0 | 1.0 |
| Sodium xylene sulphonate | | | | 4.4 |
| Oleic acid | 4.0 | | 10.0 | 13.0 |
| Primary alcohol ethoxylate (C12-15, 7EO) | 2.5 | 3.0 | 5.0 | 7.0 |
| Primary alcohol ethoxylate (C12-15, 3EO) | 2.0 | 2.5 | 4.0 | 6.0 |
| Ethanol | 2.1 | 1.0 | 3.0 | 4.0 |
| Sodium carbonate | 4.5 | 4.0 | 0.5 | |
| Tri-sodium citrate 2H₂O | 5.0 | 2.0 | 4.5 | 1.0 |
| pH (adjusted with NaOH) | 8.0 | 9.0 | 9.0 | 9.0 |
| De-ionized water: ad 100% | | | | |

An inhibitor assay was conducted as follows:

100 micro-L Savinase (1 micro-g/ml, 37 nM) and 100 micro-L buffer (50mM Glycine, 150mM KCl, 0.05mM CaCl₂, 0.01Triton X-100, pH 9.8) was incubated for 30 min at room temperature in the absence or presence of detergents 1, 2, 3 or 4 (minus inhibitor). 100 micro-L Savinase (1 μg/ml, 37 nM) and 100 micro-L BASI (13,8 micro-g/ml, 690 nM) was incubated for 30 min at room temperature in the absence or presence of detergents 1, 2, 3 or 4 (plus inhibitor).

Subsequently, 50 micro-L dissolved 4.8 mM serine protease substrate Suc-Ala-Ala-Pro-Phe-pNA (Sigma S-7388) in 50 mM Glycine, pH 9.8 was added, and the activity was measured at 405 nm over 7 min. Results are expressed as residual activity compared to the Savinase activity in the absence of inhibitor in detergent 1, 2, 3, or 4.

| | Without inhibitor | With inhibitor | Residual activity |
|---|---|---|---|
| No detergent | 339 | 42 | 12% |
| Detergent 1 | 324 | 40 | 12% |
| Detergent 2 | 290 | 44 | 15% |
| Detergent 3 | 322 | 42 | 13% |
| Detergent 4 | 281 | 44 | 16% |

The results show that BASI inhibits Savinase efficiently in the absence of detergents and equally well in the presence of detergents 1, 2, 3, and 4. Thus, the inhibition efficiency of BASI is not influenced by the presence of LAS in detergents 2 and 4 as can be seen from the almost identical results for the respective detergents 1 and 3 without LAS.

### Example 2: Stabilization of serine protease and lipase

Two liquid detergents were prepared as follows:

| | Reference | BASI detergent |
|---|---|---|
| Component | detergent | (0.044% BASI) |
| Detergent base 3 (Example 1) | 22.0 g | 22.0 g |
| Serine protease (Savinase 16.0 LEX) | 0.12 g | 0.12 g |
| Lipase (Lipex 100 L) | 0.12 g | 0.12 g |
| De-ionized water | 2.9 g | |
| BASI-solution (2.56 mg/ml) | | 4.6 g |

The detergents were placed in closed glasses at 30° C. and 35° C. Residual activity of lipase and serine protease was measured (by comparison to a reference stored at −18° C.) at different times (serine protease measured by hydrolysis of N,N-dimethylcasein at 40° C., pH 8.3 and lipase measured by hydrolysis of p-nitrophenyl valerate at 40° C., pH 7.7).

| | % residual activity | | | | |
|---|---|---|---|---|---|
| | Residual serine protease activity | | | Residual lipase activity | |
| | 3 days | 1 week | 2 weeks | 3 days | 1 week |
| Detergent | 30° C. | 35° C. | 35° C. | 30° C. | 35° C. |
| Reference | 63 | 2.3 | 0.4 | 25 | 3.3 |
| 0.044% BASI | 96 | 78 | 48 | 86 | 31 |

From the table it is clearly seen that BASI significantly stabilizes both enzymes

1. A liquid detergent composition comprising a surfactant, a serine protease and a serine protease inhibitor wherein the inhibitor has an amino acid sequence which has at least 50% identity to the mature peptide of SEQ ID NO: 1 (RASI), 2 (BASI) or 3 (WASI) or which comprises a sequence having at least 50% identity to residues 68-97 of SEQ ID NO: 1, 67-96 of SEQ ID NO: 2 or 67-96 of SEQ ID NO: 3.

2. The composition of claim 1, which further comprises a second enzyme,

3. The composition of claim 2 wherein the second enzyme is selected from amylases, lipases, cellulases, mannanases and oxidoreductases.

4. The composition of claim 1, wherein the serine protease is a subtilisin.

5. The composition of claim 1, wherein the serine protease and the inhibitor are present in a molar ratio of 1:100 to 1:1.

6. The composition of claim 1, wherein the inhibitor is present at a concentration of 0.0001% to 10% by weight.


SEQUENCE LISTING (3 sequences)

SEQ ID NO: 1 - protein, 200 aa, Oryza sativa
  mat_peptide (23)..(200)
MVSLRLPLILLSLLAISFSCSAAPPPVYDTEGHELSADGSYYVLPASPGHGGGLTMAPRVLPCPLLVAQETDERRKGFPVRFTPWGGAAAPEDRTIRVSTDVRIRFNAATICVQSTEWHVGDEPLTGARRVVTGPLIGPSPSGRENAFRVEKYGGGYKLVSCRDSCQDLGVSRDGARAWLGASQPPHVVVFKKARPSPPE

SEQ ID NO: 2 - protein, 203 aa, Hordeum vulgare
  mat_peptide (24)..(203)
MGSRRAGSSSSPLFWPAPPSRAADPPPVHDTDGHELRADANYYVLSANRAHGGGLTMAPGHGRHCPLFVSQDPNGQHDGFPVRITPYGVAPSDKIIRLSTDVRISFRAYTTCLQSTEWHIDSELAAGRRHVITGPVKDPSPSGRENAFRIEKYSGAEVHEYKLMSCGDWCQDLGVFRDLKGGAWFLGATEPYHVVVFKKAPPA

SEQ ID NO: 3 - protein, 180 aa, Triticum aestivum
DPPPVHDTDGNELRADANYYVLPANRAHGGGLTMAPGHGRRCPLFVSQEADGQRDGLPVRIAPHGGAPSDKIIRLSTDVRISFRAYTTCVQSTEWHIDSELVSGRRHVITGPVRDPSPSGRENAFRIEKYSGAEVHEYKLMACGDSCQDLGVFRDLKGGAWFLGATEPYHVVVFKKAPPA